(19) United States
(12) Patent Application Publication
(10) Pub. No.: US 2015/0061353 A1
(43) Pub. Date: Mar. 5, 2015

(54) SPOKE REORIENTABLE FOLDABLE WHEEL

(71) Applicant: National Tsing Hua University, Hsinchu City (TW)

(72) Inventor: Dongliang Daniel Sheu, Hsinchu City (TW)

(73) Assignee: National Tsing Hua University, Hsinchu City (TW)

(21) Appl. No.: 14/011,568

(22) Filed: Aug. 27, 2013

(51) Int. Cl. B60B 1/00; B60B 1/04

(52) U.S. Cl. CPC B60B 1/003; B60B 1/043; B60B 1/041
USPC 301/12.1

(57) ABSTRACT

A wheel assembly includes a hub assembly having first connecting units; spokes selectively and pivotally connected to the first connecting units of the hub assembly; at least one holding member on a peripheral surface of the hub assembly and capable of selectively securing the spokes; and a rim composed of frames and removably connected to the spokes.

### BACKGROUND OF THE INVENTION

1. Field of the Invention

This invention is related to a wheel assembly, and more particular to a bicycle wheel which is assembled by parts and capable of taking apart to be portable.

2. Description of the Related Art

In recent years, the concept of environmental protection is progressively promoted in our lives. For example, the public is enthusiastically advised to use a bicycle instead of a car for transportation, because the bicycle works without any energy and occupies small space. The largest benefit of the bike is zero-emission, which helps to reduce the pollution to the air and to prevent the earth from global warming.

However, according to the design purpose of bikes, the bike is classified into on-road (in the city), off-road (on the mountain), racing . . . etc., to meet the riders' needs. Actually, the bike is still too bulky to be carried around by users, even though there is a mechanism to fold the bike frame. This is because the wheels take a lot of space and are usually the largest component of a bike when carried.

### SUMMARY OF THE INVENTION

The primary purpose of the present invention is to provide a sectioned wheel assembly which is capable of being disassembled into parts in order to reduce the wheel size.

In order to accomplish the aforementioned purpose, the wheel assembly constructed in accordance with the present invention includes a hub assembly having first connecting units; spokes selectively and pivotally connected to the first connecting units of the hub assembly; at least one holding member on peripheral surface of the hub assembly and capable of selectively securing the spokes; and a rim composed of frames and removably connected to the spokes.

### BRIEF DESCRIPTION OF THE DRAWINGS

The invention, as well as its many advantages, may be further understood by the following detailed description and drawings in which:

FIG. 1 is an exploded, perspective view of the wheel assembly constructed in accordance with the present invention;

FIG. 2 is a perspective view of the hub constructed in accordance with the present invention;

FIG. 3A is a schematic cross sectional view showing that one spoke is inserted into one of the frames via a quick release coupling;

FIG. 3B is a schematic cross sectional view showing that the spoke is positioned in place in the frame;

FIG. 3C is a schematic cross sectional view showing that the spoke is able to be pulled out from the frame after the switch is pressed inward the quick release coupling;

FIG. 4 is an enlarged, perspective view of the spoke connected to the frame constructed in accordance with the present invention;

FIG. 5 is a perspective view of the assembled wheel constructed in accordance with the present invention;

FIG. 6 is an enlarged, perspective view of the hub constructed in accordance with the present invention;

FIG. 7 is a perspective view showing the re-oriented spokes of the present invention;

FIG. 8 is a perspective view showing the re-oriented spoke from another angle different from that of FIG. 7;

FIG. 9 is a perspective view showing all the spokes are re-oriented for portability or storage;

FIG. 10 is a view showing that the spokes are re-oriented in a same direction, such as those perpendicular or parallel to the axial direction of the hub, for portability or storage;

FIG. 11 is an enlarged, perspective view of the hub constructed in accordance with the second embodiment of the present invention;

FIG. 12A is an enlarged view showing the wheel assembly constructed in accordance with the second embodiment of the present invention; and

FIG. 12B is an enlarged view showing the notch of the hub constructed in accordance with the second embodiment of the present invention.

### DETAILED DESCRIPTION OF THE INVENTION

### First Embodiment

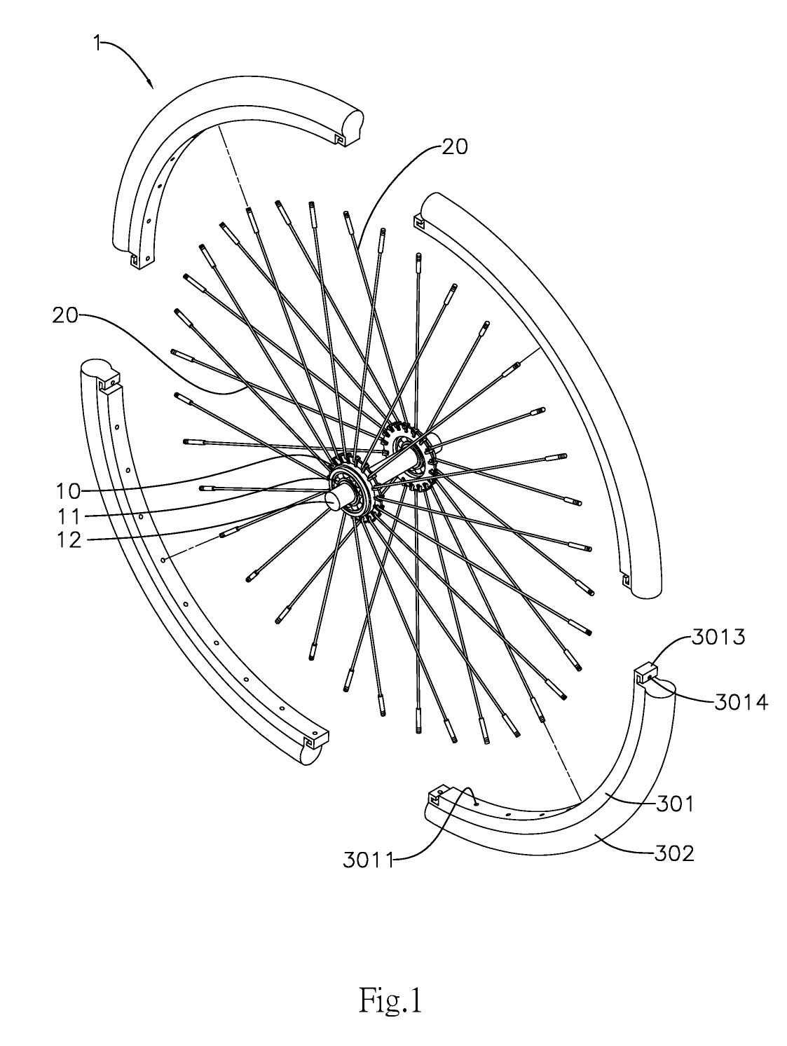

With reference to FIG. 1, a first wheel assembly 1 constructed in accordance with the first preferred embodiment of the present invention includes two first hubs 10, first spokes 20 and first frames 301. It is noted that the two first hubs 10 may be formed into one by methods well known in the art.

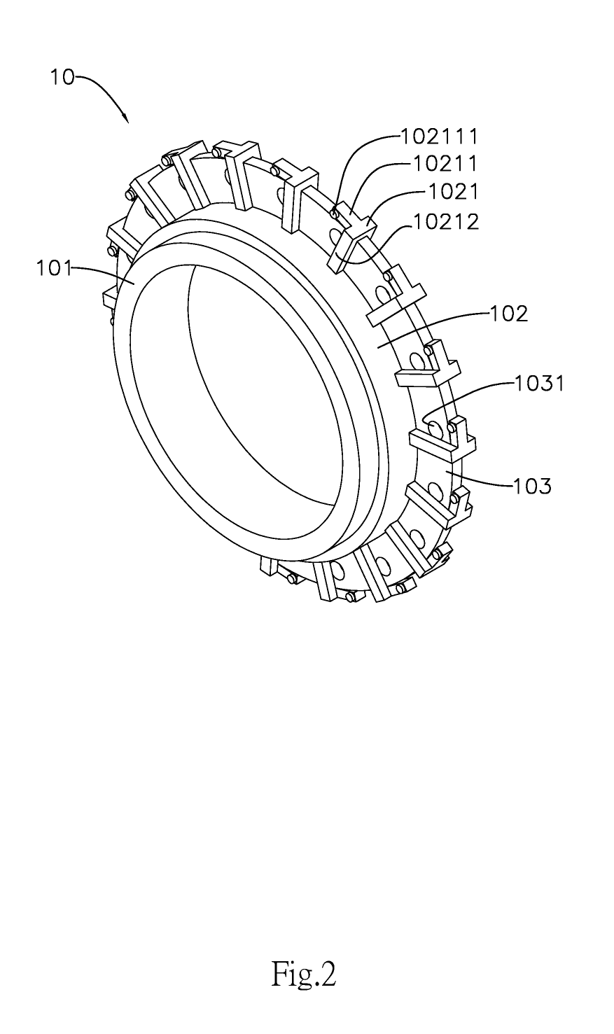

With reference to FIG. 2, each of the first hubs 10 includes a first sleeve 101, a first ring 102 movably, rotatable to be precise, mounted around an outer peripheral surface of the first sleeve 101 and a first disk 103 securely formed on an outer surface of the first sleeve 101. The first sleeve 101 has a centrally defined hole to receive a bearing 11 and an axel 12 (as shown in FIG. 1). With the provision of another bearing (not shown) between the first sleeve 101 and the first ring 102, the first ring 102 is able to be smoothly rotated relative to the first sleeve 101. Because the rotatable movement of the first ring 102 relative to the first sleeve 101 is conventional in the art, detailed description thereof is omitted for brevity. The first ring 102 has a plurality of blocking elements 1021 securely formed on the peripheral outer surface thereof and each blocking element 1021 has two parallel legs 10212 with a distance therebetween to accommodate a portion of the first disk 103 and a protrusion 10211 vertically extending outward from the two legs 10212 of the blocking element 1021 and in a direction along with a circumferential edge of the first disk 103. The protrusion 10211 further has a first bump 102111 formed on a side thereof. The first disk 103 has first perforations 1031 defined to penetrate the first disk 103. The two legs 10212 of each of the blocking elements 1021 is formed as an “n” shape so that the first disk 103 is able to move through a space defined by the two legs 10212 of the blocking element 1021.

Referring back to FIG. 1, each of the first spokes 20 is used to support the first frames 301. A distal end of each of the first spokes 20 is formed with a hook, such that after each hook extends into a corresponding first perforation 1031 in the first disk 103, every first spoke 20 is securely connected to the first disk 103.

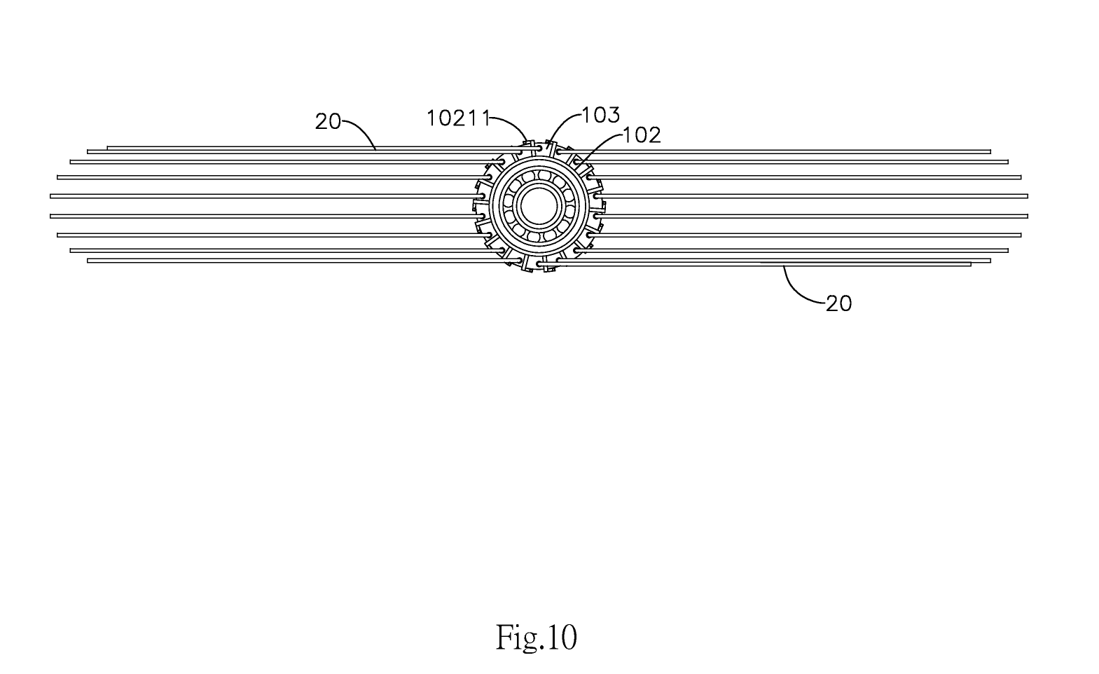

Even though the first spokes 20 are securely connected to the first disk 103 due to the provision of the two legs 10212 as well as the first bumps 102111, spinning the first ring 102 may force the first spokes 20 to pass over the limitation set forth by the first bump 102111. After the first spokes 20 are free from the limitation of the blocking elements 1021, each first spoke 20 is re-orientable as the hook of each of the first spokes 20 still remains in the corresponding first perforation 1031. Under such a situation, the user may divide the first spokes 20 into categories, preferably two as shown in FIG. 10, to reduce space once storage is necessary.

In the first preferred embodiment, the material for the first spokes 20 is selected from a group consisting of steel, aluminum and carbon.

Referring back to FIG. 1, each of the first frames 301 has a cushion 302 such as rubber affixed on a side face thereof and holes 3011 defined in a side face thereof to correspond to and receive therein the other distal ends of the first spokes 20.

In the first preferred embodiment, the cushion 302 is a solid resilient structure or an inflatable hollow structure. Furthermore the surface of the cushion 302 has grooves (not shown) to provide friction.

In the first preferred embodiment, the distal end of each of the first spokes 20 and the inner wall of each of the holes 3011 are threaded (not shown), such that the first spokes 20 are able to be threaded into the corresponding holes 3011.

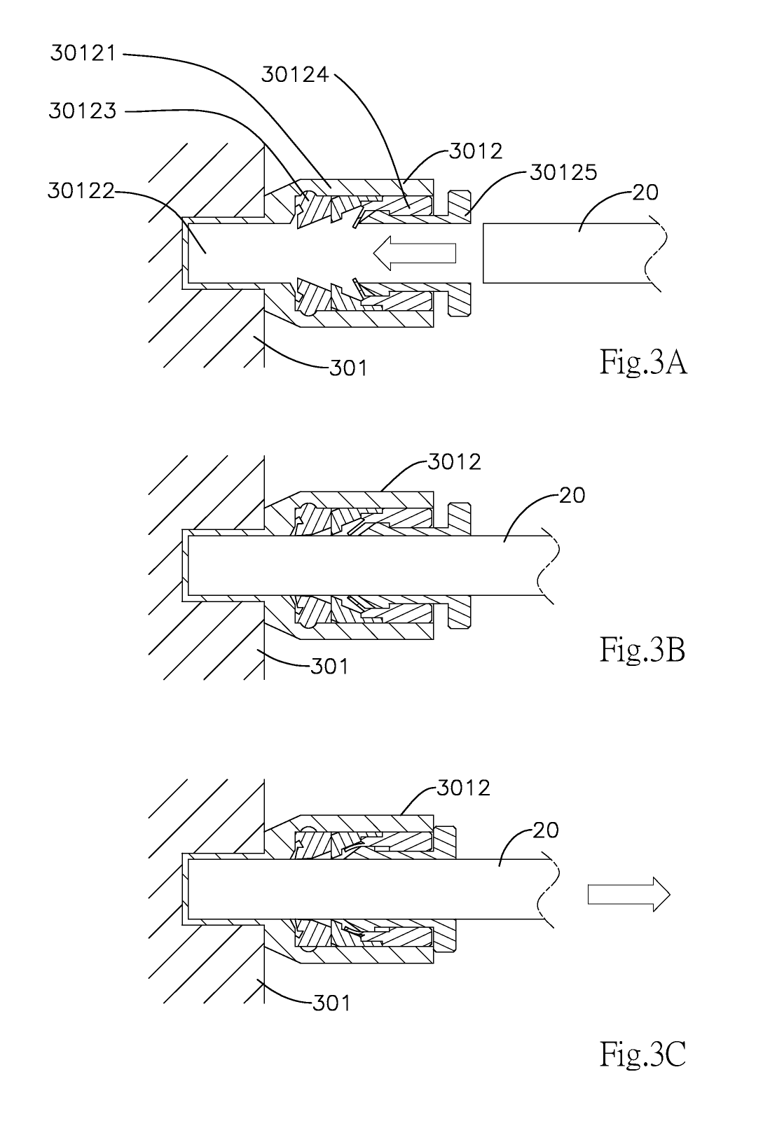

With reference to FIG. 3A-3C, each of the holes 3011 is able to be replaced by a connector 3012 that is partially embedded in the frame 301. The connector 3012 is somewhat like a quick release coupling 3012 having a housing 30121, a passage 30122 defined in the housing 30121 for receiving the first spoke 20, a block assembly 30123 formed on an inner wall defining the passage 30122 of the housing 30121, paddles 30124 deformably formed on the inner wall of the housing 30121 and next to the block assembly 30123 and a sliding element 30125 slidably movable inside the passage 30122 so as to selectively connect to the paddles 30124. The block assembly 30123 is resilient to tightly hold the first spoke 20 once a distal end of the first spoke 20 is inserted into the passage 30122. If the first spokes 20 are to be removed for the purpose of storage, the user may push he sliding element 30125 inward the passage 30122. After the sliding element 30125 is pushed deep inside the passage 30122, the paddle 30124 is then forced by the movement of the sliding element 30125 to deform. It is noted that when the paddle 30124 is deformed, the deformation of the paddle 30124 will then force the block assembly 30123 to deform in a direction directed to the inner sidewall defining the passage 30122. While the block assembly 30123 is deformed, the tight-fit relationship of the block assembly 30123 with an outer periphery of the first spoke 20 is then released. Consequently, the other distal end of the first spoke 20 is able to be pulled out of the passage 30122 for storage purpose.

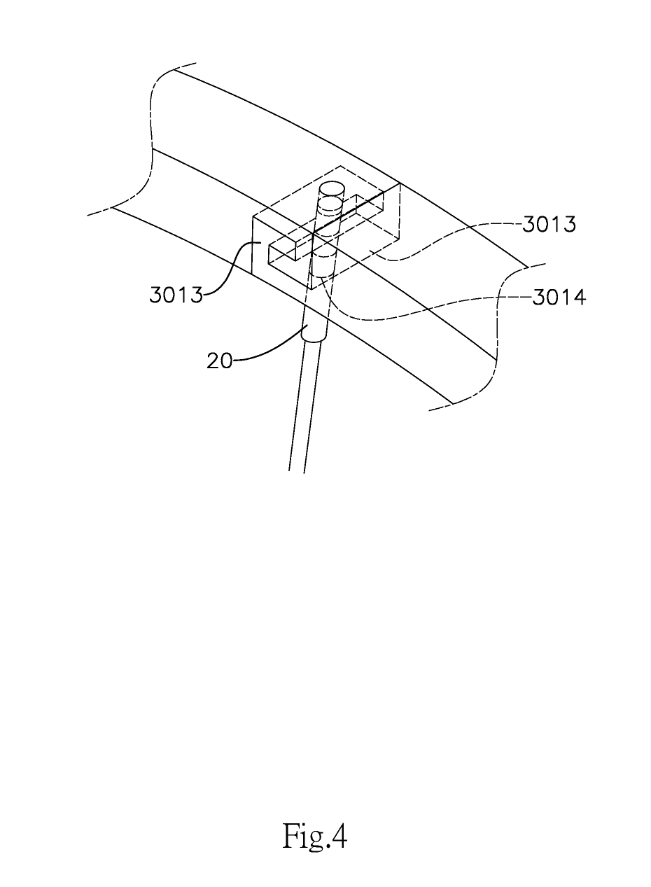

With reference to FIGS. 1 and 4, two mated notches 3013 are individually defined on both distal ends of each of the first frames 301, such that the first frames 301 are connected together through the connection of the notches 3013 mated with each other and without conflicting the cushions 302, because one distal end of the cushion 302 is extending to correspond to a distal end of the first frame 301 and another distal end of the cushion 302 is extending to another distal end of the first frame 301 without covering the notch 3013. The connection where two notches 3013 mated together further defines therethrough a channel 3014 to receive therein the distal end of one first spoke 20 to prevent the connected first frames 301 from being separated. The material of the first frame 301 is selected from a group consisting of aluminum alloy and steel.

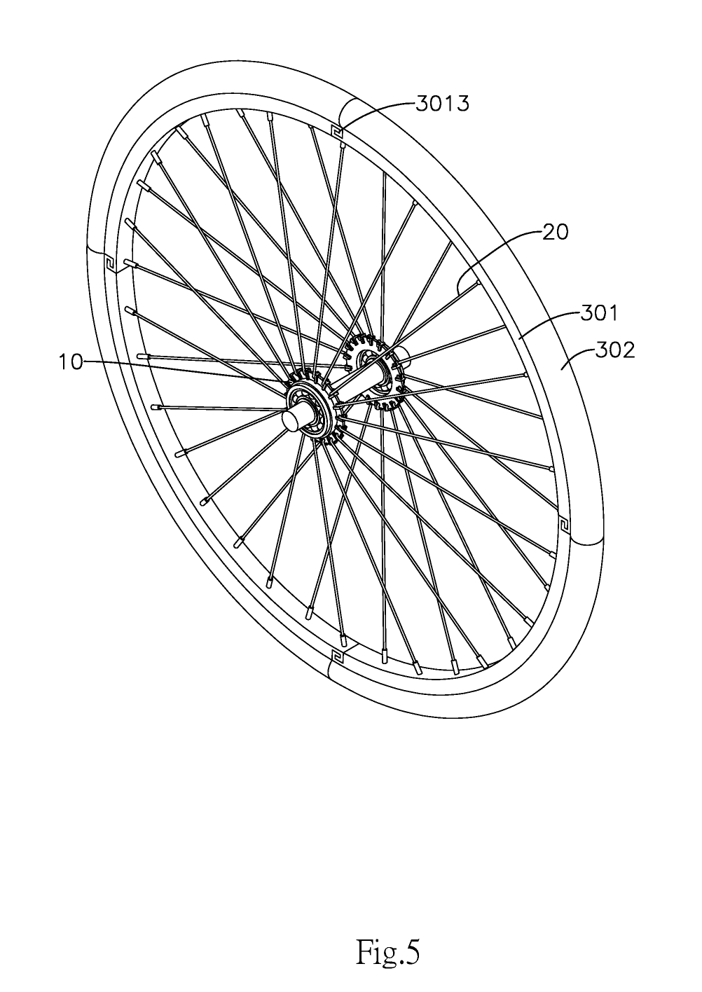

With reference to FIG. 5, the first wheel assembly 1 is assembled after the first spokes 20 are correspondingly and securely inserted into the holes 3011 of the first frames 30 and the notches 3013 of the first frames 30 are mated with each other to construct a rim.

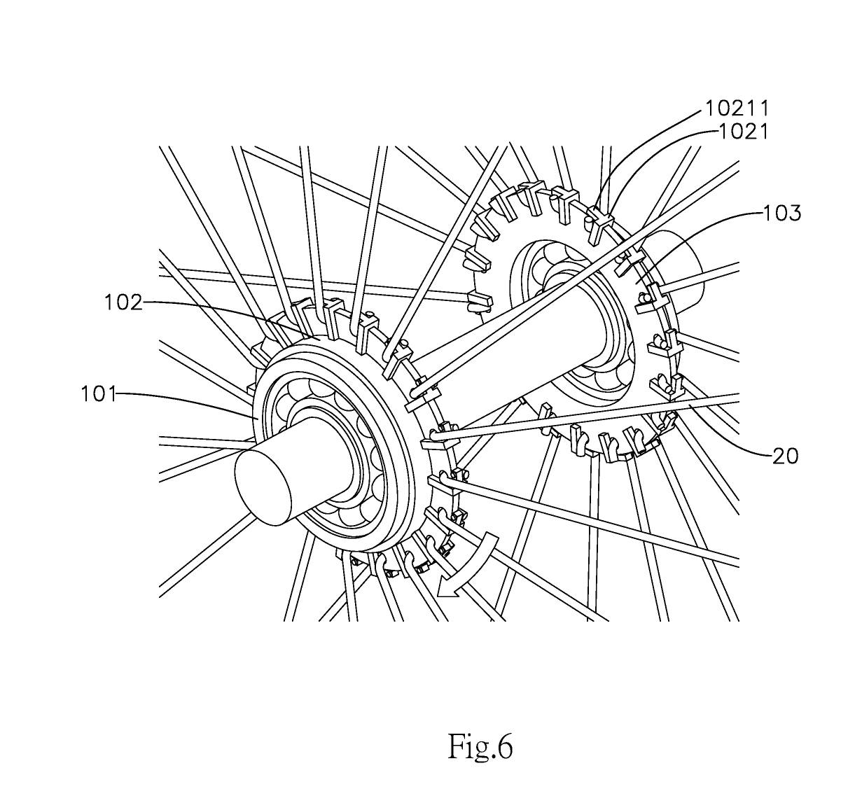

With reference to FIG. 6, to disassemble the first spokes 20 from the rim, it is necessary to first rotate the first ring 102 to enable the first spoke 20 to pass over the first bump 102111 so as to define a pivotal path for each of the first spokes 20, and then the first spokes 20 become pivotable.

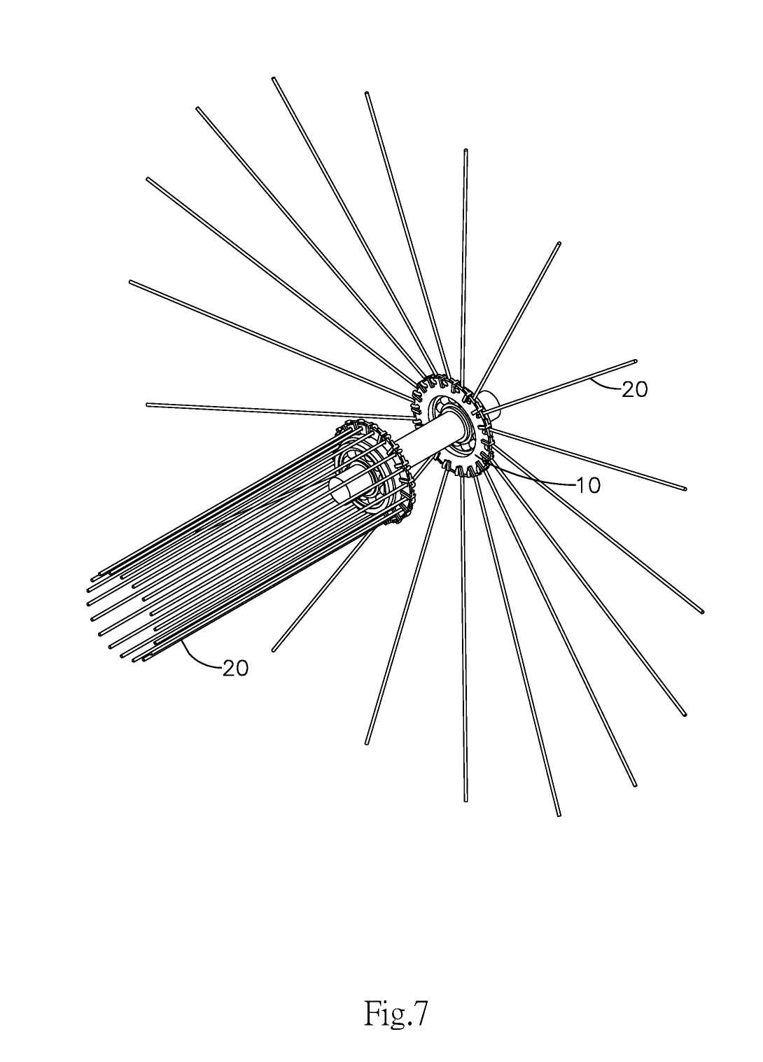

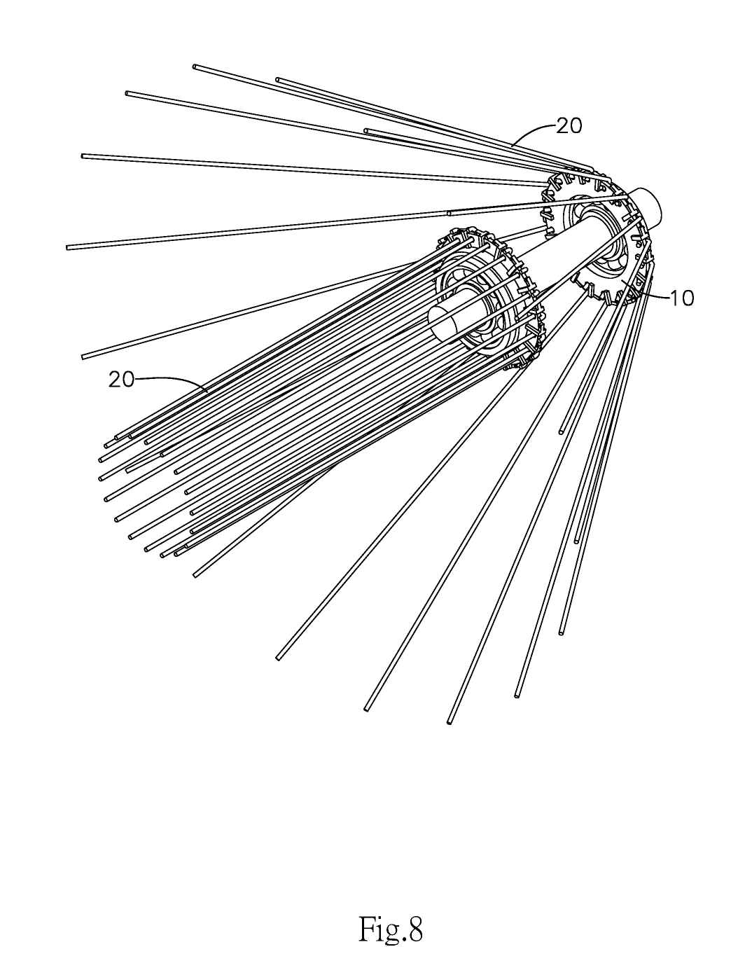

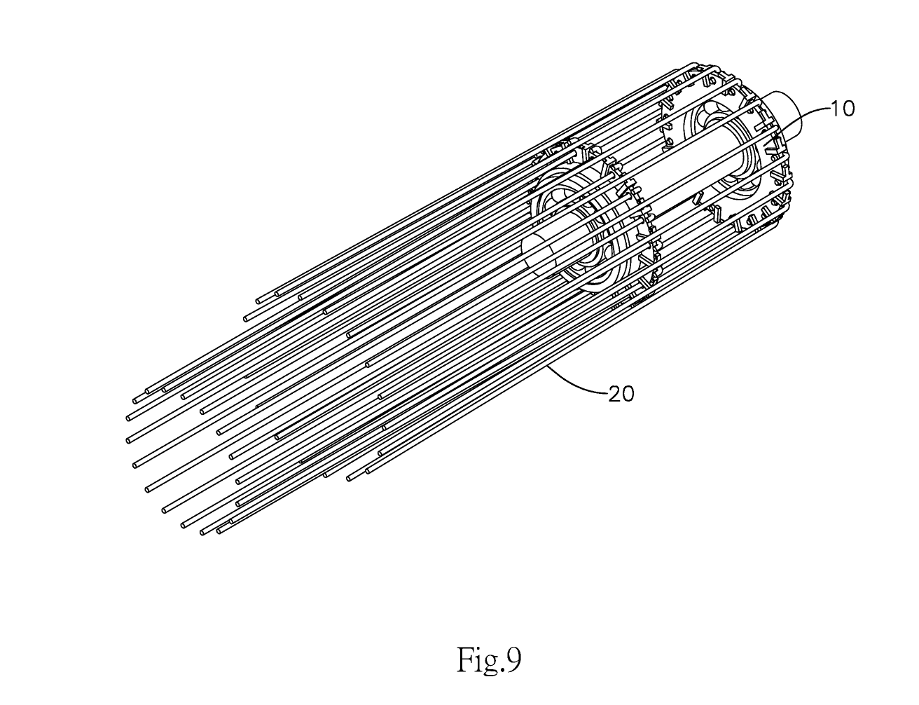

With reference to FIGS. 7-9, after the first spokes 20 are away from the blocking elements 1021 and the distal ends of all the first spokes 20 are also away from connection with the first frames 301, the first spokes 20 are able to be re-oriented to the same direction to reduce the original occupied space of the first wheel assembly 1.

With reference to FIG. 10, which shows another application that the first spokes 20 are able to be re-oriented in another direction for portability.

In the first preferred embodiment, each of the first spokes 20 is constructed by a telescopic structure (not shown) which provides an adjustable ability to the length of each of the first spokes 20 capable of being shorten into smaller size.

### Second Embodiment

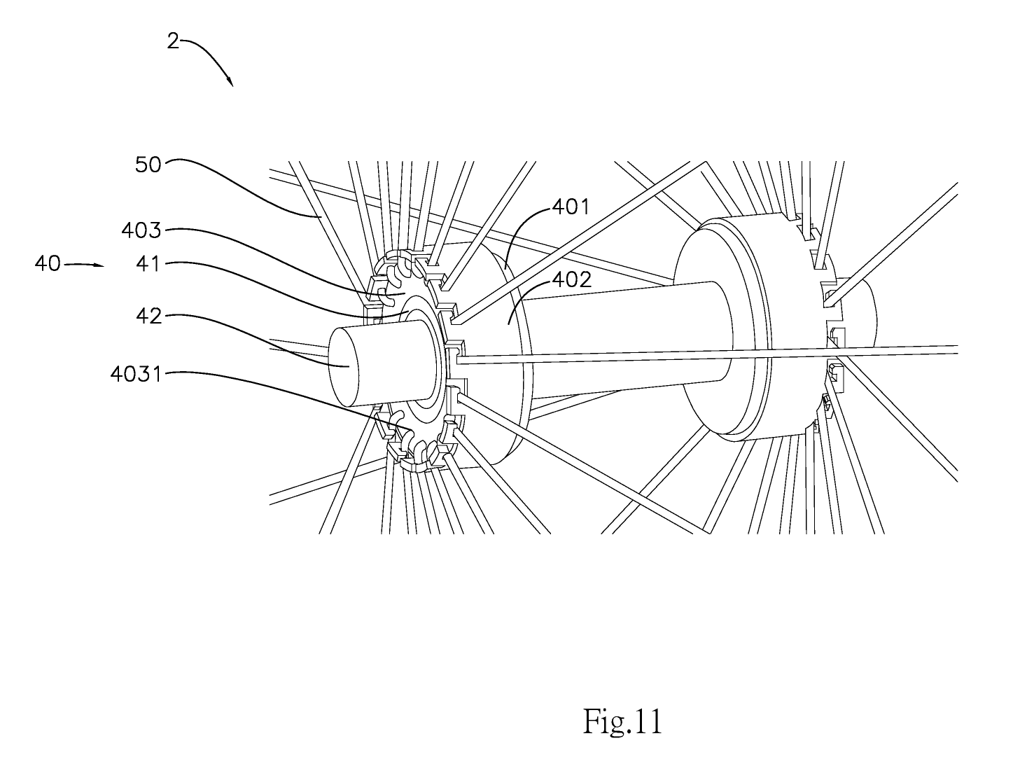

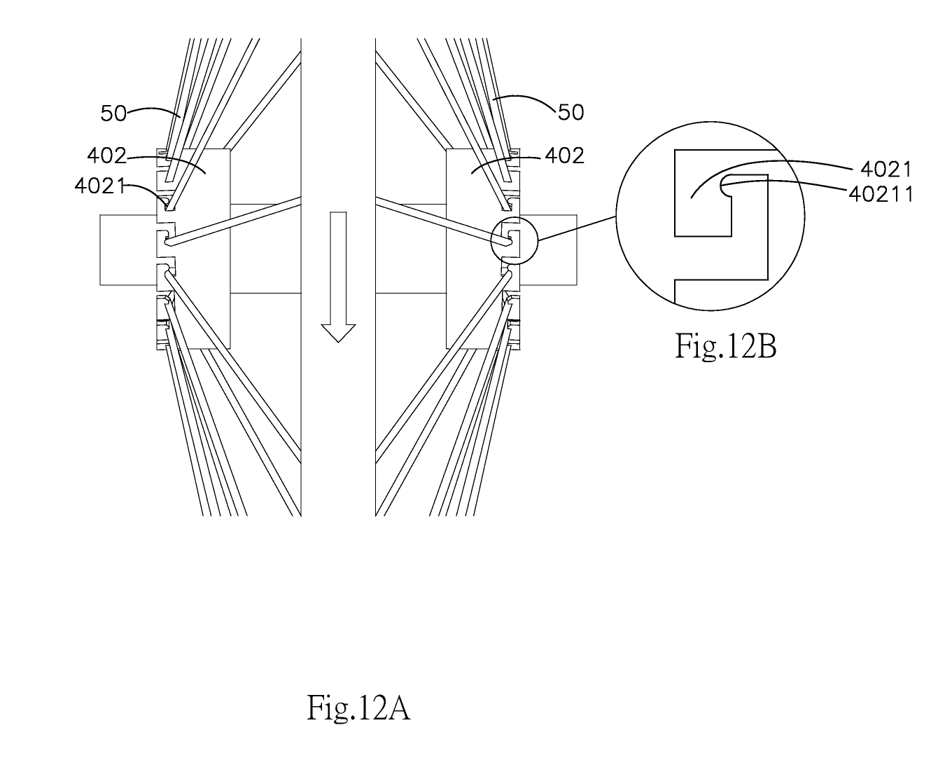

With reference to FIGS. 11-12B, a wheel assembly 2 constructed in accordance with the second preferred embodiment of the present invention includes two second hubs 40, second spokes 50 and second frames (not shown).

It is to be noted that the two second hubs 40 may be formed as one hub assembly via a method known in the art. As a result of this, the following explanation is only for explanatory purpose and should not be construed as a limitation to the scope sought for protection. Each of the second hubs 40 includes a second sleeve 401, a second ring 402 movably, rotatably to be precise, mounted around an outer peripheral surface of the second sleeve 401. The second sleeve 401 has a centrally defined hole (not numbered) to receive a bearing 41 and an axel 42 (as shown in FIG. 11). With the provision of another bearing (not shown) between the second sleeve 401 and the second ring 402, the second ring 402 is able to be smoothly rotated relative to the second sleeve 401. Due to the rotatable movement of the second ring 402 relative to the second sleeve 401 is conventional in the art, detailed description thereof is omitted for brevity. The second ring 402 has cutouts 4021 defined on a round edge of the second ring 402, where each of the cutouts 4021 is constructed into a letter “L”. The second ring 402 further has second bumps 40211 respectively formed on an inner surface defining the L-shaped cutout 4021 showing in FIG. 12B.

The second hub 40 further includes a second disk 403 provided around a circumferential edge of the second sleeve 401 and having a centrally defined hole to expose the bearing 41 and the axel 42. The second disk 403 has second perforations 4031 defined to penetrate the second disk 403.

The second spokes 50, the same structure with the first spoke 20 described in the first preferred embodiment of the invention, has a hook formed on a distal end thereof, such that after each hook extends into a corresponding second perforation 4031 in the second disk 403, every second spoke 50 is pivotally connected to the second disk 403.

Due to the second frames are the same structure as the first frame 301 and the same connection to the spokes described in the first preferred embodiment of the present invention, the detailed description thereof is omitted for brevity.

Same as the aforementioned first preferred embodiment, the second spokes 50 have two modes provided by rotating the second ring 402. In the first mode, each of the second spokes 50 is un-pivotal while each of the L-shaped cutouts 4021 is moved to receive therein each of the second spokes 50. In the second mode, each of the second spokes 50 is pivotable while each of the L-shaped cutouts 4021 is moved to receive therein each of the second spokes 50 in the L-shaped cutouts 4021, such that each of the second spokes 50 is able to be re-oriented along the cutouts 4021 to depart from the second ring 402.

It is noted that the bumped L-shape lock contour 4021 on FIGS. 12A and 12B of the second ring 402 is designed to enforce the secured holding of the spokes when the wheel is moving forward and when the tangential force on the spoke is higher. The arrowhead on the FIG. 12A indicate the direction of the ground force on the rim which, in turn, push the spoke against the lock for self-secured locking In addition, the bump 40211 provides sufficient holding force to secure the spoke when the bike is rotating backward at a much slower speed whilst facilitates the spoke to get out of the lock for folding purpose.

In the second preferred embodiment, the distal end of each of the second spokes 50 are able to be threaded (not shown) to be screwed into the corresponding threaded holes of the second frame (not shown).

In the second preferred embodiment, the material for each of the second spokes 50 is selected from the group consisting of steel, aluminum and carbon.

In conclusion, the aforementioned preferred embodiments of the present invention provides the wheel assemblies 1,2 whose spokes 20, 50 are pivotally connected to the hub 10, 40, and the frames 301 are removably connected to the spokes 20, 50, such that the wheel assemblies 1, 2 are capable of being divided into parts to reduce the space occupied to be carried around by users.

Many changes and modifications in the above described embodiment of the invention are able to, of course, be carried out without departing from the scope thereof. Accordingly, to promote the progress in science and the useful arts, the invention is disclosed and is intended to be limited only by the scope of the appended claims.

What is claimed is:

1. A wheel assembly comprising
a hub assembly;
spokes directly or indirectly connected to the hub assembly capable of re-oriented and lined up toward a same direction possibly parallel or perpendicular to the axial direction of the hub when unlocked by their holding means;
at least one holding means on a peripheral surface of the hub assembly and capable of securing the spokes; and
a rim removably connected to the spokes and capable of being segmented for portability.

2. The wheel assembly as claimed in claim 1, wherein a distal end of each of the spokes is a hook pivotally connecting to a first connecting unit on the hub assembly.

3. The wheel assembly as claimed in claim 2, wherein each of the first connecting units is a hole to receive the hook of each of the spokes.

4. The wheel assembly as claimed in claim 1, wherein the rim is composed of a rigid frame and a cushion ring firmly attached on a peripheral face of the rigid frame.

5. The wheel assembly as claimed in claim 4, wherein the rigid frame further comprises second connecting units to removably connect with the spokes.

6. The wheel assembly as claimed in claim 5, wherein each of the second connecting units is selected from a group consisted of a quick releasing coupling and a threaded hole.

7. The wheel assembly as claimed in claim 4, wherein the rigid frame are segmented, each pair of the connecting frame has two matching notches respectively defined in the connecting ends thereof, such that the frames is able to be connected mutually to form the rim when the matched notches are engaged.

8. The wheel assembly as claimed in claim 7, wherein each of the notches further provides with a through hole defined on both connecting ends of the segmented frames, such that one end of the spoke is able to engage the through holes to secure the connected frames.

9. The wheel assembly as claimed in claim 1, wherein at least one holding member is able to self-enforcing the holding of the spokes when the wheel assembly rotates.

10. The wheel assembly as claimed in claim 1, wherein each of the spokes is of telescopic structure or with flexible length.
